(19) United States
(12) Patent Application Publication
(10) Pub. No.: US 2008/0264217 A1
(43) Pub. Date: Oct. 30, 2008

(54) Pliers

(75) Inventor: Jose Ignacio Picaza Ibarrondo, Abadiano (Vizcaya) (ES)

Correspondence Address: LUCAS & MERCANTI, LLP, 475 PARK AVENUE SOUTH, 15TH FLOOR, NEW YORK, NY, 10016, US

(73) Assignee: ROTHENBERGER, S.A., ABADIANO (ES)

(21) Appl. No.: 12/066,531

(22) PCT Filed: Apr. 7, 2006
(86) PCT No.: PCT/ES2006/000166

§ 371 Date: Mar. 12, 2008

(51) Int. Cl. B25B 7/12

(52) U.S. Cl. 81/367

(57) ABSTRACT

Pliers, with two arms that are joined together via an articulation pin. One of the arms has a protuberance with a lateral channel that extends via one of the orifices, a pusher being located in the channel and having an inner channel that accommodates a spring that acts between the pusher and the arm. The articulation pin is joined by means of screwing to the pusher in the region of the lateral channel, a toothed claw being arranged coaxially therebetween with mechanical continuity. The pusher is continued as an extension located on the walls of the other orifice in the work position. Applicable to hand tools.

The subject of the invention refers to pliers of the type used in plumbing, for example.

This type of pliers is already known in the current state of the technique. Adjustable pliers are even known, comprised of two arms that are joined together by an articulating bolt and where one of the arms can be progressively adjusted in an almond-shaped window of the other arm to vary the size of the jaws of the pliers.

Based on this need to vary the size of the jaws of the pliers, lo some pliers have been developed with a very reliable, solid and easy-to-handle mechanism, that permits going quickly from a work position (where the jaws of the pliers maintain their constant separation whilst the arms/jaws mutually rotate to open/close) to an adjustment position (where one arm moves in a linear direction with respect to the other in the almond-shaped window). The Spanish patent P20501312, of the same applicant refers to this type of pliers, for example.

The pliers targeted by the invention offer a more simplified construction, eliminating the bushing that, in Patent 200501312, is inserted between the pawl and the pusher which is now a single-block piece that carries out the function of pusher and bushing.

The advantages of eliminating the bushing and inserting this single-block part (pusher+bushing) are as follows:

a) the total number of pliers parts is reduced

b) it permits better alignment of the locking system as fewer components intervene

c) it requires less machining demands, on not having to align so many components

d) smoother operation

e) less risk of it seizing up, and

f) easier to assemble on not having to position the bushing in its housing or having to hold it.

In order to understand the subject of this invention better, a preferential form of practical execution is illustrated on the drawings, subject to incidental changes that take nothing away from its foundation.

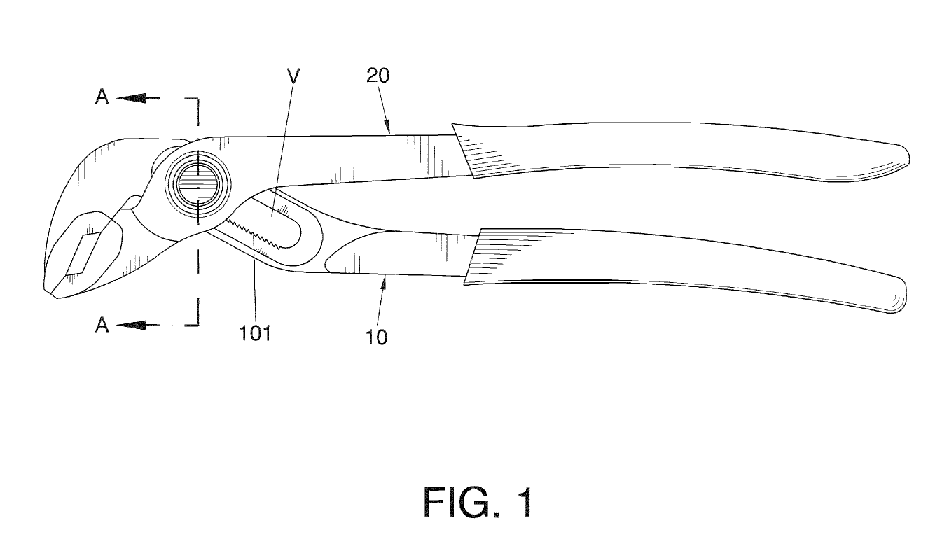

FIG. 1 shows a general elevation view of some pliers according to the invention for a—non-limiting—example of practical execution.

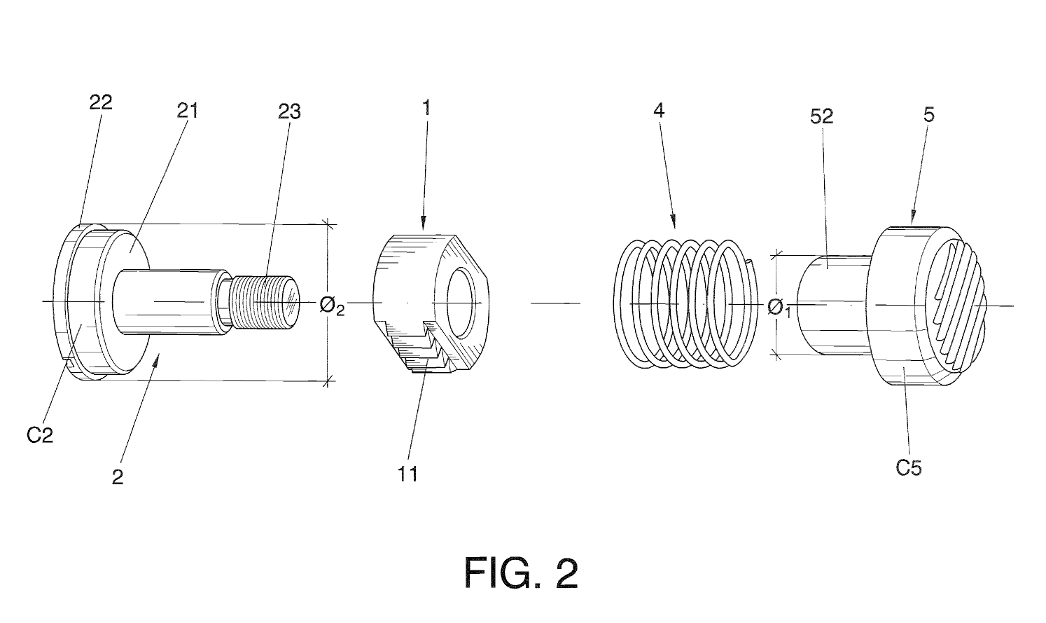

FIG. 2 shows a general perspective view of the adjustment shaft (2) with the remaining components—toothed pawl (1), spring (4) and pusher (5)—ready to mount.

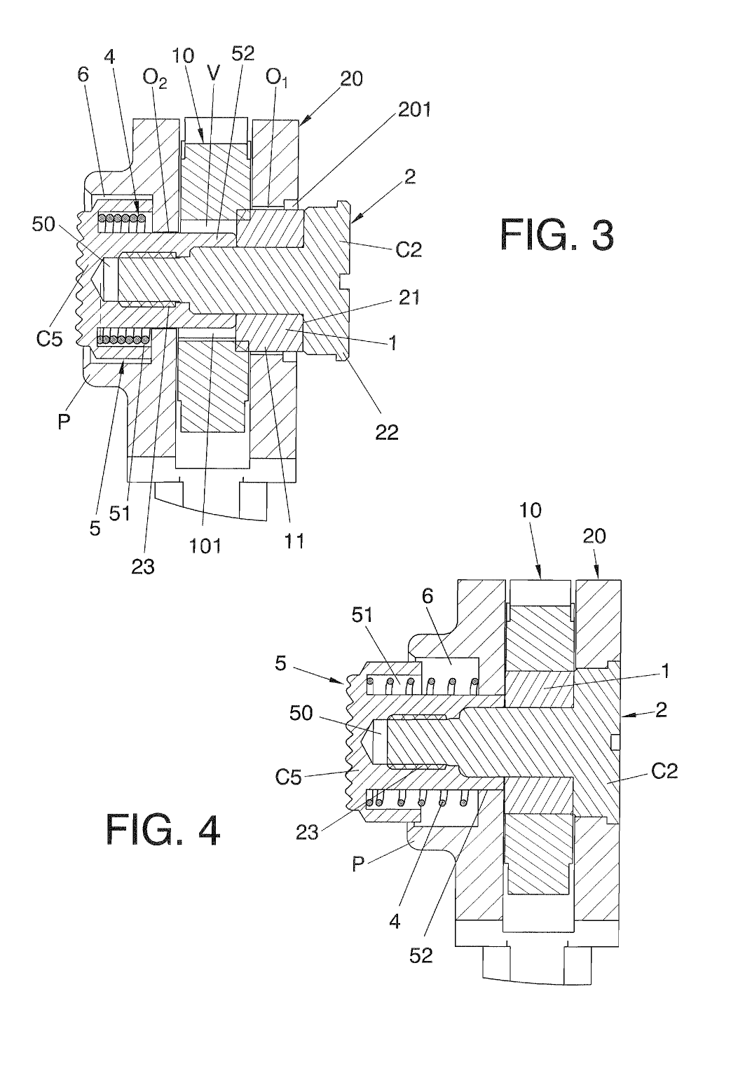

FIG. 3 shows a general amplified section, according to indication A:A of FIG. 1, to execute FIG. 2, in adjustment position.

FIG. 4 shows a general amplified section, according to indication A:A of FIG. 1, to execute FIG. 2 in work position.

An example of a non-limiting practical execution of this invention is described below.

The subject of this invention refers to pliers of the type made up of two arms, one male (10) and another female (20), which bear the respective jaw clamps. These arms (10) and (20) are joined together by a hinge pin (2), which, forming the spin axis of the female arm (20), has multiple and progressive positions in an almond-shaped window (V) of the male arm (10) to vary the size of the jaw of the pliers.

As it is commonly known, the female arm (20) defines some coaxial openings, a first one (O₁) and a second one (O₂) where the hinge pin (2) is mounted, which has a toothed pawl (1) which may or may not engage with a toothing (101) defined in the almond-shaped window (V) of the male arm (10).

In agreement with the invention, and according to the execution shown in FIGS. 2 to 4:

The female arm (20) bears a side protuberance (P) on which a side box-shaped opening (6) has been executed, coaxial with the two openings (O₁), (O₂) of the female arm (20).

On one end, the hinge pin (2) defines a headpiece (C₂), with a surrounding ledge (22) and an internal seat (21 ) and, on the other end, a threaded area (23). The ledge (22), seat (21) and the threaded area (23) preferably have a successively smaller diameter: The ledge (22) with a greater diameter than the seat (21); both with greater diameter than the central area of the pin (2) and all of them with a greater diameter than the end threaded area (23)—although this geometry is not limiting and if altered, the essence of the invention does not change.

A toothed pawl (1) is placed in the central area of the pin (2) limited at the side by the seat (21). This toothed pawl (1) forms some outer teeth (11), which may or may not engage in some conjugated teeth (101) foreseen in the almond-shaped window (V) of the male arm (10).

There is a threaded pusher (5) in the end area (23) of the pin (2). This pusher (5) coaxially defines an inner box-shaped opening (51) and an extension (52) with an opening (50) on the inside which goes beyond its headpiece (C₅), where this inner box-shaped opening (51) is formed—see FIGS. 3 and 4.

The internal opening (50), threaded at its base, permits the pin (2) to be screwed in (23), leaving the extension (52) of the pusher (5) unscrewed, accompanying the central area of the pin (2) and being limited at the side by the aforementioned toothed pawl (1), in mechanical continuity.

In particular, the toothed pawl (1) and, at least, the extension (52) of the pusher (5) are made of wear-resistant material.

There is an internal spring (4) that acts between the pusher (5) and the female arm (20): housed coaxially in these box-shaped openings (6), (51) and acting against its bases, whose aim is to separate the pusher (5) from the female arm (20) and, consequently, to maintain the pin (2) in an extreme position where the toothed pawl (1) maintains its teeth (11) engaged in the conjugated teeth (101) foreseen in the almond-shaped window (V) of the male arm (10).

Openings (O₁), (O₂) of the female arm (2) have different diameters and, respectively, conjugated from the pin (2) in its seating area (21) and of the extension (52) of the pusher (5). In particular, the diameter of the first opening (O₁) is greater than the diameter of the second opening (O₂).

With this structure and assembly, a simple manual pressure on the pusher (5) compresses the spring (4) and moves the pin (2) together with the toothed pawl (1) mounted on it, until the teeth (11) of the toothed pawl (1) are released from the teeth (101) of the male arm (10). As long as pressure is maintained on the pusher (5), its extension (52) remains opposite the teeth (101) and this extension (52) can move freely in the window (V) together with the pin (2) and female arm (20) to vary the size of the jaws of the pliers.

1. Pliers, comprising with two arms, a male arm and a female arm which are joined together by a hinge pin; and where the female arm can be progressively adjusted in an almond-shaped window of the male arm to vary the size of the jaws of the pliers; a first coaxial opening is defined in the female arm as well as a second coaxial opening where the hinge pin is mounted, which has a toothed pawl which, depending on whether it is in the work position or adjustment position, may or may not engage with toothing defined in the almond-shaped window of the male arm; wherein:
a) the female arm comprises a protuberance where a side box-shaped opening has been executed which extends along the second opening; this box-shaped opening houses a pusher which has an inner box-shaped opening where a spring is located, which acts between the pusher and the female arm;
b) the hinge pin is screwed to the pusher in the area of the side box-shaped opening, with a toothed paw being placed coaxially between them and with mechanical continuity; and
c) the pusher has push means in mechanical continuity with the toothed pawl and pin, which is located on the walls of the second opening in the work position.

2. Pliers, according to claim 1, wherein the push means is an extension which extends beyond the pusher.

3. Pliers, according to claim 1, wherein the diameter Ø1 of the first opening is greater than the diameter Ø2 of the second opening: Ø1>Ø2

4. Pliers, according to claim 1, wherein the first opening defines a seating on which, in work position, a conjugated ledge of pin rests; so that the head of the pin does not stand out with respect to the side of the female arm.

5. Pliers, according to claim 1, wherein the toothed pawl and, at least, the extension of the pusher are made of wear-resistant material.
